(19) United States
(12) Patent Application Publication
(10) Pub. No.: US 2025/0297847 A1
(43) Pub. Date: Sep. 25, 2025

(54) MEASURING APPARATUS

(71) Applicant: MITUTOYO CORPORATION, Kanagawa (JP)

(72) Inventors: Atsushi SHIMAOKA, Tokyo (JP); Satoshi YOSHITANI, Tokyo (JP); Koichi ONDA, Kanagawa (JP); Kazuya IWASAKI, Kanagawa (JP)

(73) Assignee: MITUTOYO CORPORATION, Kanagawa (JP)

(21) Appl. No.: 19/087,854

(22) Filed: Mar. 24, 2025

(30) Foreign Application Priority Data
Mar. 25, 2024 (JP) 2024-048323

(51) Int. Cl. G01B 5/016

(52) U.S. Cl. CPC G01B 5/016

(57) ABSTRACT

A coordinate measuring machine (measuring apparatus) includes: a probe (measurement performing unit) performing a measurement process on a measurement target; an electrical section disposed in a part of the probe; a temperature sensor provided for the electrical section and outputting a detection signal based on a temperature obtained by measurement; and a controller (measurement calculator) calculating a measurement result of the measurement target, in which the controller calculates the measurement result by compensating a measurement value obtained by the measurement process based on a processed signal obtained by applying a low-pass filter to the detection signal output from the temperature sensor.

### CROSS REFERENCE TO RELATED APPLICATIONS

The entire disclosure of Japanese Patent Application No. 2024-048323 filed Mar. 25, 2024 is expressly incorporated by reference herein.

### TECHNICAL FIELD

The present invention relates to a measuring apparatus.

### BACKGROUND ART

When a measuring apparatus measures coordinates on a surface of a measurement target, it is necessary to take into account a dimensional change in the measuring apparatus due to a temperature change, that is, a dimensional change caused by elongation of the measuring apparatus due to thermal expansion. For instance, Literature 1 (JP 2005-181293 A) describes a measuring apparatus (coordinate measuring machine) in which a probe may include a temperature sensor that measures a temperature of the probe and a temperature compensation of measurement data may further be performed based on a temperature difference between a measured temperature of the probe and a reference temperature (normally 20 degrees C.).

The measuring apparatus as described above performs a compensation process based on the temperature obtained by the measurement of the temperature of the probe. Here, the probe may include a stylus, a support that supports the stylus, a mechanism section that is provided inside the support and configures a movement mechanism of the stylus, a sensor, and an electrical section. In this case, when an electrical component provided for the electrical section is energized, the electrical component becomes a heat source.

In the probe, however, it takes a longer time for the heat to propagate with distance from the electrical section including the electrical component as the heat source, making a temperature increase to the elapsed time slow. Further, heat dissipates more greatly with distance from the electrical section, resulting in a decrease in saturated temperature. For that reason, elongation of the entire probe calculated from a measurement value of the temperature sensor does not immediately match actual elongation of the entire probe, when the temperature sensor is provided for the electrical section that is the heat source. Thus, when compensation is performed based on the temperature measured by the temperature sensor, for instance, immediately after the power source of the measuring apparatus is turned on, it is not possible to perform a proper compensation process corresponding to the elongation of the entire probe, and a user is required to wait until the temperature increase reaches saturation.

The measuring apparatus may include temperature sensors for respective parts of the probe, and the temperature sensors may measure the temperatures of the respective parts of the probe. In this case, however, a space for the temperature sensors is needed to prevent the temperature sensors from interfering with the measurement target and other components of the measuring apparatus. In addition, providing the multiple temperature sensors increases apparatus costs, and wiring becomes complex due to wiring lines drawn from the respective temperature sensors to the electrical section.

It should be noted that the above problems may be applied not only to the measuring apparatus provided with the probe as described in Literature 1 but also to any other measuring apparatus in which a temperature sensor is provided for an electrical section disposed in a measurement performing unit that performs measurement. For instance, in a length measuring machine that measures a length of a measurement target, the length of the measurement target is measured by moving, on a scale along a longitudinal direction, a detection head that is the electrical section. Such a length measuring machine may perform a compensation process corresponding to a dimensional change due to a temperature change in the scale. Here, the temperature sensor may be provided for the electrical section (e.g., the detection head) disposed slightly separated from the scale as a temperature measurement target. In this case, as with the probe, it takes time for the heat of the electrical section to be propagated to the scale, which may lead to a gap between elongation of the entire scale calculated from a measurement value of the temperature sensor and actual elongation of the entire scale. This makes it impossible to perform the proper compensation process for the temperature, until the temperature increase in the electrical section and the scale reaches saturation.

### SUMMARY OF THE INVENTION

An object of the invention is to provide a measuring apparatus capable of performing a proper compensation process corresponding to an actual temperature in a measurement performing unit.

A measuring apparatus according to a first aspect of the present disclosure includes: a measurement performing unit configured to perform a measurement process on a measurement target; an electrical section disposed in a part of the measurement performing unit; a temperature sensor provided for the electrical section and configured to output a detection signal based on a temperature obtained by measurement; and a measurement calculator configured to calculate a measurement result of the measurement target, in which the measurement calculator is configured to calculate the measurement result by compensating a measurement value obtained by the measurement process based on a processed signal obtained by applying a low-pass filter to the detection signal output from the temperature sensor.

### BRIEF DESCRIPTION OF DRAWINGS

FIG. 1 schematically illustrates an exemplary measuring apparatus according to a first exemplary embodiment.

FIG. 2 illustrates temperature changes in respective parts of a probe according to the first exemplary embodiment.

FIG. 3 illustrates an example of elongation of the entire probe due to a temperature increase.

FIG. 4 illustrates an exemplary relationship between a temperature measured by a temperature sensor and a temperature based on a processed signal after a low-pass filtering process in the first exemplary embodiment.

FIG. 5 illustrates exemplary variations in coordinates of measurement results with respect to elapsed time.

FIG. 6 schematically illustrates an exemplary measuring apparatus according to a second exemplary embodiment.

FIG. 7A illustrates an exemplary low-pass filter circuit.

FIG. 7B illustrates another exemplary low-pass filter circuit.

FIG. 7C illustrates a further exemplary low-pass filter circuit.

FIG. 7D illustrates a still further exemplary low-pass filter circuit.

FIG. 8 schematically illustrates an exemplary measuring apparatus according to a third exemplary embodiment.

FIG. 9 schematically illustrates an exemplary measuring apparatus according to a fourth exemplary embodiment.

### DETAILED DESCRIPTION

### First Exemplary Embodiment

Description will be made below on a measuring apparatus according to a first exemplary embodiment of the present disclosure.

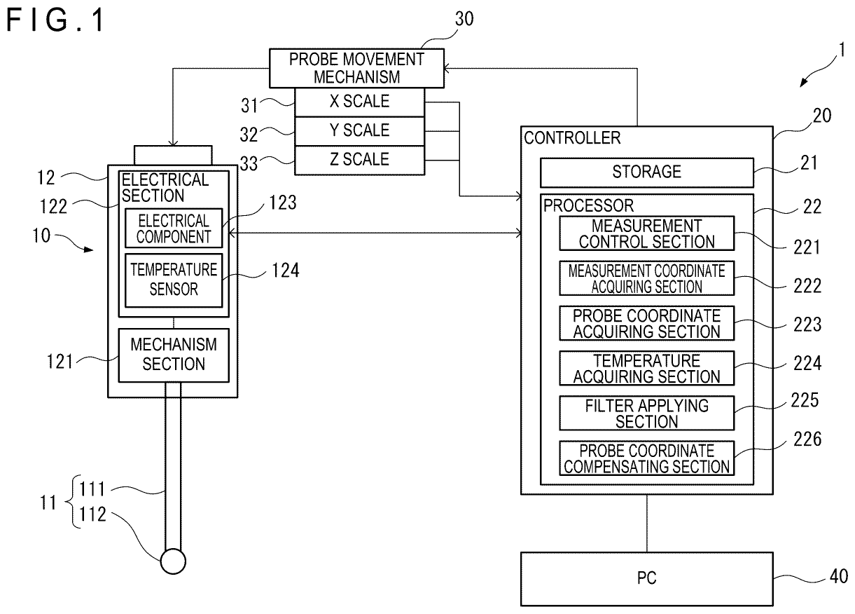

FIG. 1 schematically illustrates a coordinate measuring machine that is an exemplary measuring apparatus of the first exemplary embodiment.

In FIG. 1, a coordinate measuring machine 1 includes a probe 10, a controller 20, a personal computer (PC) 40, and the like. Further, the coordinate measuring machine 1 includes a table (not illustrated) on which a measurement target is placed, and a probe movement mechanism 30 that moves the probe 10 in an X direction, a Y direction orthogonal to the X direction, and a Z direction orthogonal to the X and Y directions. The probe movement mechanism 30 includes an X scale 31 that measures an amount of movement in the X direction, a Y scale 32 that measures an amount of movement in the Y direction, and a Z scale 33 that measures an amount of movement in the Z direction.

The probe 10 corresponds to a measurement performing unit of the present disclosure. The probe 10 includes a stylus 11 and a support 12 that supports the stylus 11.

The stylus 11 includes a shaft 111 and a tip ball 112 provided at the tip of the shaft 111. When the coordinate measuring machine 1 measures a shape of a measurement target, the controller 20 controls the probe movement mechanism 30 to cause the probe 10 to move in a three-dimensional space so that the tip ball 112 of the stylus 11 moves along a surface of the measurement target.

The support 12 supports a base end of the stylus 11 (an end opposite the tip ball 112 of the shaft 111) so that the stylus 11 is movable. The support 12 is, for instance, a cylindrical member having a predetermined diameter. A mechanism section 121 and an electrical section 122 are provided inside the support 12.

The mechanism section 121 supports the stylus 11 so that the stylus 11 is movable. Specifically, the mechanism section 121 supports the stylus 11 so that the stylus 11 is movable in a predetermined range to an axial direction of the stylus 11 (Zp direction), an Xp direction orthogonal to the Zp direction, and a Yp direction orthogonal to the Xp direction and the Zp direction. Further, the mechanism section 121 includes a probe sensor (not illustrated) that measures the amounts of movement of the stylus 11 in the Zp, Xp, and Yp directions, as probe coordinates.

The electrical section 122 is an electrical board on which a temperature sensor 124 and any other electrical component 123 than the temperature sensor 124 are mounted. For instance, the probe coordinates are detected by the probe sensor and the temperature is measured by the temperature sensor 124.

The temperature sensor 124 is built in the support 12 of the probe 10, and directly provided for the electrical section 122, which is the electrical board.

The temperature sensor 124 measures a temperature of the probe 10, which is the measurement performing unit of the present disclosure.

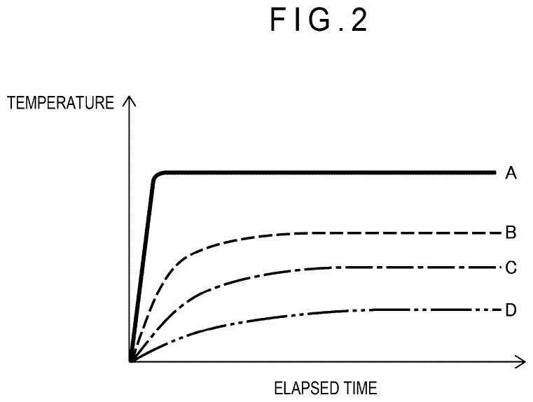

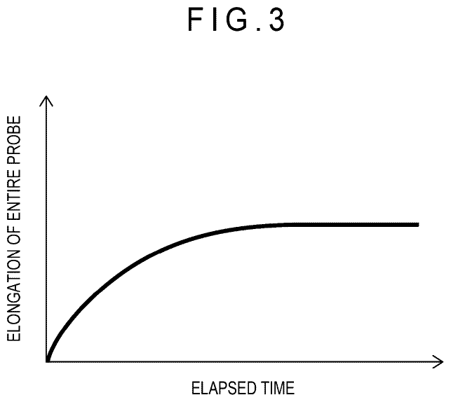

Here, a temperature increase in the probe 10 will be described. FIG. 2 illustrates temperature changes in respective parts of the probe 10. FIG. 3 illustrates an example of elongation of the entire probe 10 due to a temperature increase.

In the probe 10 of the first exemplary embodiment, when the electrical component 123 provided for the electrical section 122 is energized, the electrical component 123 becomes a heat source, causing a temperature increase. Since the temperature sensor 124 is provided for the electrical section 122 together with the electrical component 123, a temperature measured by the temperature sensor 124 is substantially the same as that of the electrical component 123 along with the temperature increase in the electrical component 123, exhibiting a steep temperature change, as indicated by a line A in FIG. 2.

In FIG. 2, a temperature increase at a position in the mechanism section 121 close to the electrical section 122 is indicated by a line B, a temperature increase at a position in the mechanism section 121 close to the stylus 11 is indicated by a line C, and a temperature increase in the stylus 11 is indicated by a line D. As indicated by the lines A to D of FIG. 2, the heat generated in the electrical component 123 is propagated to respective parts of the probe 10 so that heat propagation is delayed with distance from the electrical section 122, and the saturated temperature decreases with distance from the electrical section 122. Thus, the rate of temperature increase and the degree of temperature increase differ in the respective parts of the probe 10. As a result, as illustrated in FIG. 3, elongation of the entire probe 10 has a slower change than the temperature measured by the temperature sensor 124.

For the above reason, if a dimensional change of the probe 10 due to the temperature change is compensated using the temperature measured by the temperature sensor 124 as it is, the value for this compensation is not consistent with that based on an actual dimensional change of the probe 10. Thus, in the first exemplary embodiment, a low-pass filtering process is applied to the temperature measured by the temperature sensor 124 to calculate a compensation value corresponding to the actual dimensional change of the probe 10. The compensation using a low-pass filter will be described later.

The controller 20 corresponds to a measurement calculator of the present disclosure. The controller 20 controls the entirety of the coordinate measuring machine 1 to perform measurement on a measurement target using the probe 10 and to output a coordinate measurement result. The measurement calculator of the present disclosure may be configured by the controller 20 and the later-described personal computer (PC) 40. For instance, the controller 20 is configured including at least a storage 21 and a processor 22. The storage 21 stores a variety of programs and a variety of data. The processor 22 achieves a variety of functions by reading and executing the programs recorded in the storage 21.

More specifically, the processor 22 functions as a measurement control section 221, a measurement coordinate acquiring section 222, a probe coordinate acquiring section 223, a temperature acquiring section 224, a filter applying section 225, and a probe coordinate compensating section 226 by reading and executing the variety of programs.

The measurement control section 221 controls the probe movement mechanism 30 to move the probe 10 relative to the measurement target. For instance, the measurement control section 221 refers to design data for the measurement target, measurement coordinates measured by the measurement coordinate acquiring section 222, and the like, and moves the probe 10 along a predetermined locus. Alternatively, the measurement control section 221 may refer to probe coordinates measured by the probe coordinate acquiring section 223 and may control the probe movement mechanism 30 to make an amount of pushing of the probe constant.

The measurement coordinate acquiring section 222 acquires measurement coordinates (X, Y, Z) of the probe 10, i.e., the amounts of movement in the XYZ directions of the probe 10 measured by the X scale 31, the Y scale 32, and the Z scale 33.

The probe coordinate acquiring section 223 acquires probe coordinates (Xp, Yp, Zp) measured by the probe sensor provided for the probe 10.

The temperature acquiring section 224 acquires a detection signal corresponding to a measurement temperature output from the temperature sensor 124.

The filter applying section 225 applies the low-pass filtering process to the detection signal acquired by the temperature acquiring section 224 and outputs a signal after the low-pass filtering process as a processed signal. That is, in the first exemplary embodiment, the processor 22 functions as the filter applying section 225 by reading and executing a filter program recorded in the storage 21. The filter applying section 225 generates the processed signal from the detection signal through an arithmetic process based on the filter program.

For instance, a low-pass filter of Formula (1) is used, in which the detection signal output from the temperature sensor 124 is denoted by R, the processed signal is denoted by Y, a time constant of the low-pass filter is denoted by τ, and a Laplace operator is denoted by s.

$$Y ( s ) = \frac{1}{1 + τ s} R ( s ) \qquad ( 1 )$$

Given that the temperature measured by the temperature sensor 124 is denoted by T_{S}, the temperature after the low-pass filtering process (temperature used for a later-described compensation process) is denoted by T_{L}, and a sampling period of the detection signal output from the temperature sensor 124 is denoted by Δt, Formula (2) is obtained from Formula (1).

$${T}_{L} [ n ] = {aT}_{L} [ n - 1 ] + ( 1 - a ) {T}_{S} [ n ] \\ where \\ a = τ / ( Δ t + τ ) \qquad ( 2 )$$

In Formula (2), n represents the n-th sampling, T_{L}[n] represents a temperature T_{L} after the n-th low-pass filtering process, T_{L}[n−1] represents a temperature T_{L} after the (n−1)-th low-pass filtering process, and T_{S}[n] represents a temperature T_{S} obtained by the n-th measurement using the temperature sensor 124.

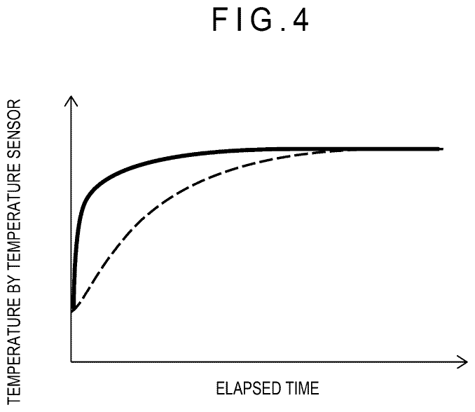

FIG. 4 illustrates an exemplary relationship between the temperature T_{S} measured by the temperature sensor 124 and the temperature T_{L} based on the processed signal after the low-pass filtering process. FIG. 4 illustrates a relationship of the temperatures T_{S}, T_{L} to the time elapsed after the power source of the coordinate measuring machine 1 is switched from OFF to ON, the temperature T_{S} represented by a solid line, the temperature T_{L} represented by a dashed line.

By turning on the power source of the coordinate measuring machine 1, the electrical component 123 of the electrical section 122 is energized, making the electrical component 123 a heat source to increase the temperature. The temperature sensor 124 is directly provided for the electrical section 122. Thus, when the electrical component 123 of the electrical section 122 is energized, the temperature T_{S} steeply increases and then stabilizes at a predetermined temperature, as illustrated in FIGS. 2 and 4.

In contrast, the temperature T_{L} after the low-pass filtering process is calculated as represented by Formula (2), and the temperature T_{L} increases slower than the temperature T_{S} and stabilizes at a predetermined temperature, as illustrated in FIG. 4.

As understood from the comparison between FIG. 3 and FIG. 4, the dashed line representing the temperature T_{L} after the low-pass filtering process in FIG. 4 is close in shape to the solid line representing the elongation of the entire probe 10 in FIG. 3, and the dimensional change of the probe 10 due to the temperature increase can be properly compensated by performing the compensation process based on the temperature T_{L} after the low-pass filtering process.

The probe coordinate compensating section 226 outputs compensated probe coordinates obtained by compensating the probe coordinates based on the temperature T_{L} that corresponds to the processed signal calculated by the filter applying section 225. In the first exemplary embodiment, an example is given in which the probe coordinate compensating section 226 sets the probe coordinates measured by the probe sensor as a measurement value and compensates the measured probe coordinates to provide probe coordinates as a measurement result. The present disclosure, however, is not limited thereto. For instance, the measurement result may be provided by setting, as the measurement value, a value obtained by adding the probe coordinates measured by the probe sensor to the measurement coordinates measured by the measurement coordinate acquiring section 222, and adding the compensation value to this value.

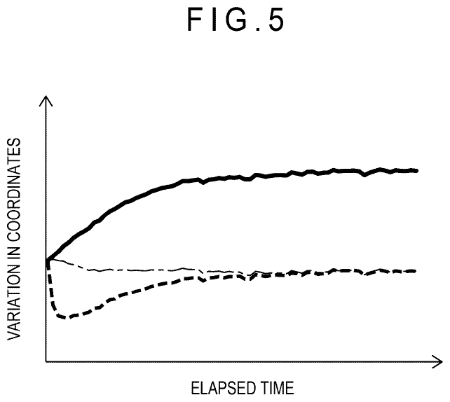

FIG. 5 illustrates exemplary variations of measurement results. In FIG. 5, a dashed-dotted line represents a variation in coordinates of a measurement result after the compensation process based on the temperature T_{L}, a dashed line represents a variation in coordinates of a measurement result after the compensation process based on the temperature T_{S}, and a solid line represents a variation in coordinates of a measurement result before the compensation process (without the compensation process).

In the exemplary measurement results illustrated in FIG. 5, when the power source of the coordinate measuring machine 1 is switched from OFF to ON, the temperature of each part of the probe 10 changes with the electrical section 122 serving as the heat source, elongating the entire probe 10. Here, heat is slowly propagated to each part of the probe 10 compared to the temperature T_{S} measured by the temperature sensor 124, as described above. Thus, the actual elongation of the entire probe 10 gradually changes, and also the measurement result gradually changes as indicated by the solid line in FIG. 5. As understood from the comparison with FIG. 4, the solid line representing the change in the measurement result in FIG. has substantially the same shape as the dashed line representing the change in the temperature T_{L} after the low-pass filtering process in FIG. 4.

The probe coordinate compensating section 226 compensates the measurement value to cancel out such a dimensional change of the probe 10 due to the temperature change, and outputs the compensated value as the measurement result.

For instance, in a case of the measurement result compensated based on the temperature T_{S} indicated by the dashed line in FIG. 5, the compensation amount is too large immediately after the power source is switched from OFF to ON, resulting in a great change in the measurement result. In this case, a certain period of time is needed to saturate the temperature increase in each part of the probe 10 and to stabilize the elongation of the entire probe 10 at a constant value. Although the measurement result compensated properly is obtained after the certain period of time, it takes time to obtain the proper measurement result.

In contrary, the measurement result is calculated by compensating the measurement value based on the temperature T_{L} corresponding to the processed signal after the low-pass filtering process in the first exemplary embodiment. This makes it possible to perform the compensation corresponding to the actual elongation of the probe 10 as indicated by the dashed-dotted line in FIG. 5, and to calculate the proper measurement result while greatly reducing or eliminating the waiting time.

In the above, although the description has been made about the compensation in the axial direction (Zp direction) of the probe 10 that is large in an elongation/contraction amount due to the temperature change, similar compensation may be performed in the Xp direction and the Yp direction.

### Shape Calculation by PC

The PC 40 is connected communicatively to the coordinate measuring machine 1. The PC 40 calculates surface coordinates or a surface shape of the measurement target based on the compensated probe coordinates compensated by the probe coordinate compensating section 226 and the measurement coordinates measured by the X scale 31, Y scale 32, and Z scale 33. For instance, when profiling movement of the probe 10 is performed along a surface of the measurement target, the coordinates of a locus of contact positions with the tip ball 112 of the probe 10 are each calculated based on the compensated probe coordinates and the measurement coordinates.

### Workings and Effects of First Exemplary Embodiment

The coordinate measuring machine 1 of the first exemplary embodiment includes the stylus 11 that performs a measurement process on a measurement target, the probe 10 including the support 12 that supports the stylus 11, and the controller 20. The support 12 of the probe 10 is provided with the electrical section 122 and the temperature sensor 124. The electrical section 122 includes the electrical component 123 that controls the probe 10. The temperature sensor 124 is provided for the electrical section 122 and outputs a detection signal based on a temperature obtained by measuring a temperature of the probe 10. The controller 20 calculates a measurement result by compensating a measurement value obtained by the measurement using the stylus 11 based on a processed signal obtained by applying a low-pass filter to the detection signal output from the temperature sensor 124.

In the first exemplary embodiment, the measurement result is calculated by compensating the measurement value based on the processed signal obtained by applying the low-pass filter to the detection signal. Thus, it is possible to calculate the measurement result corresponding to the actual elongation of the entire probe 10 in place of the steep temperature change by the temperature sensor 124. Accordingly, the probe coordinate compensating section 226 can output the compensated probe coordinates with high accuracy immediately after the power source of the coordinate measuring machine 1 is switched from OFF to ON, which consequently enables the PC 40 to calculate the measurement result with a small measurement error.

In the first exemplary embodiment, the low-pass filter is a filter program recorded in the storage 21. The processor 22 is configured to read and execute the filter program and to generate the processed signal by performing the arithmetic process for applying the low-pass filter to the detection signal output from the temperature sensor 124.

This eliminates the necessity of separately providing a low-pass filter circuit, thus simplifying the configuration of the coordinate measuring machine 1. Also, such a configuration facilitates the update of the filter program. For instance, the filter program may be updated depending on the installation environment of the coordinate measuring machine 1, the replacement of the entire probe 10 or the stylus 11, or the like, allowing the time constant T to be updated to an optimal value as appropriate.

In the first exemplary embodiment, the probe 10, which includes the stylus 11 configured to make contact with the measurement target and the support 12 supporting the stylus 11, serves as the measurement performing unit of the present disclosure, and the electrical section 122 and the temperature sensor 124 are provided inside the support 12 of the probe 10.

Such a probe 10 is capable of performing the proper compensation process corresponding to the elongation of the entire probe 10, as described above. In addition, it is only necessary in the first exemplary embodiment to provide the single temperature sensor 124. This configuration is simpler than a configuration in which the temperature sensors are provided for the respective parts of the probe 10 such as the stylus 11. Further, the temperature sensor 124 does not interfere with the measurement target and other components of the coordinate measuring machine 1 and the wiring of the temperature sensor 124 is also simplified.

### Second Exemplary Embodiment

Next, description will be made on a second exemplary embodiment. In the first exemplary embodiment, the low-pass filter is a software program. The processor 22 of the controller 20 reads and executes the filter program in the storage 21 to function as the filter applying section 225, which applies the low-pass filter to the detection signal output from the temperature sensor 124 (arithmetic process). On the other hand, a case using a low-pass filter circuit is given as an example in the second exemplary embodiment.

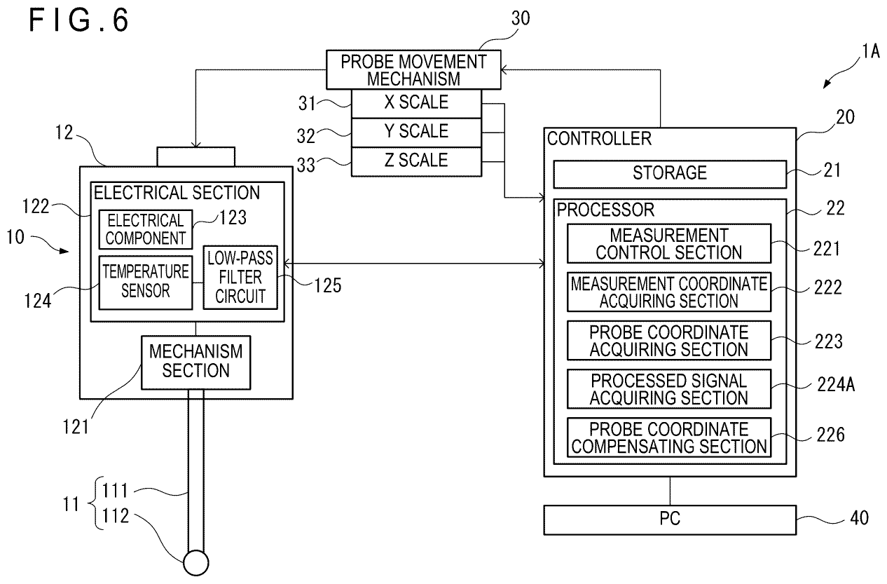

FIG. 6 illustrates a schematic configuration of a coordinate measuring machine 1A of the second exemplary embodiment. In the second exemplary embodiment, the same components as those in the first exemplary embodiment are denoted by the same reference numerals to simplify or omit the description of the components.

The coordinate measuring machine 1A of the second exemplary embodiment includes the probe 10, the controller 20, and the PC 40 as in the first exemplary embodiment.

In the probe 10 of the second exemplary embodiment, the electrical section 122 that is the electrical board is further provided with a low-pass filter circuit 125. A detection signal output from the temperature sensor 124 is input to the low-pass filter circuit 125, and a processed signal output from the low-pass filter circuit 125 is input to the controller 20.

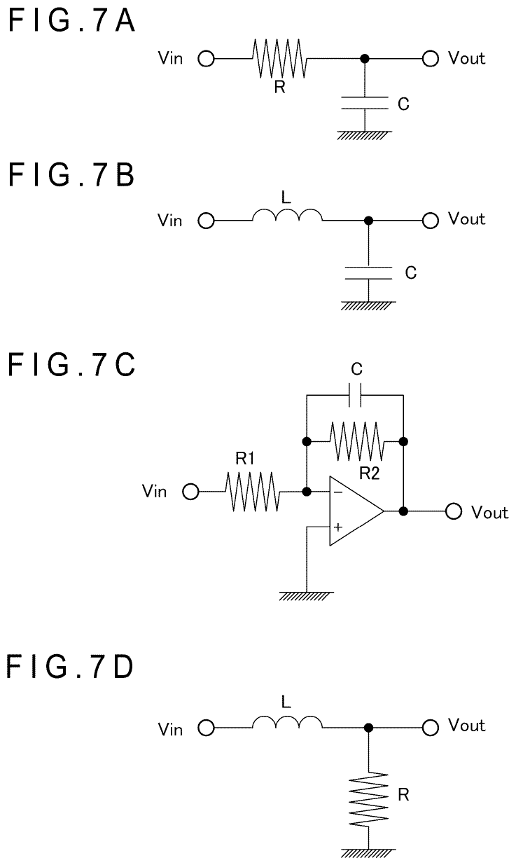

FIGS. 7A to 7D are each an example of the low-pass filter circuit 125. The low-pass filter circuit 125 is not particularly limited. For instance, an RC low-pass filter circuit as illustrated in FIG. 7A is usable. In addition to that, exemplary usable circuits include an LC low-pass filter circuit as illustrated in FIG. 7B, a low-pass filter circuit using an operational amplifier as illustrated in FIG. 7C, and an LR low-pass filter circuit as illustrated in FIG. 7D. The examples of the low-pass filter circuit 125 illustrated in FIGS. 7A to 7D are different in the time constant τ. However, all the examples of the low-pass filter circuit 125 in FIGS. 7A to 7D are capable of processing the detection signal input from the temperature sensor 124 to the processed signal illustrated in FIG. 4 and outputting the processed signal.

The low-pass filter circuit 125 is provided in the second exemplary embodiment. Thus, the processor 22 of the controller 20 needs not function as the filter applying section 225.

Thus, the processor 22 in the second exemplary embodiment functions as a processed signal acquiring section 224A, rather than the temperature acquiring section 224 in the first exemplary embodiment. The processed signal acquiring section 224A acquires a processed signal input from the temperature sensor 124 to the controller 20 through the low-pass filter circuit 125, i.e., a processed signal after the low-pass filtering process. The probe coordinate compensating section 226 then outputs a measurement result obtained by compensating a measurement value based on a temperature T_{L} that corresponds to the processed signal acquired by the processed signal acquiring section 224A.

### Workings and Effects of Second Exemplary Embodiment

The coordinate measuring machine 1A of the second exemplary embodiment achieves workings and effects similar to those of the first exemplary embodiment.

In addition to that, in the coordinate measuring machine 1A of the second exemplary embodiment, the processed signal is generated by processing the detection signal from the temperature sensor 124 in the low-pass filter circuit 125. It is thus possible to reduce a load relating to the arithmetic process of the processor 22.

### Third Exemplary Embodiment

In the first exemplary embodiment, the example is given in which the processor 22 of the controller 20 functions as the filter applying section 225. In a third exemplary embodiment, an example is given in which the filter applying section 225 is provided in the probe 10.

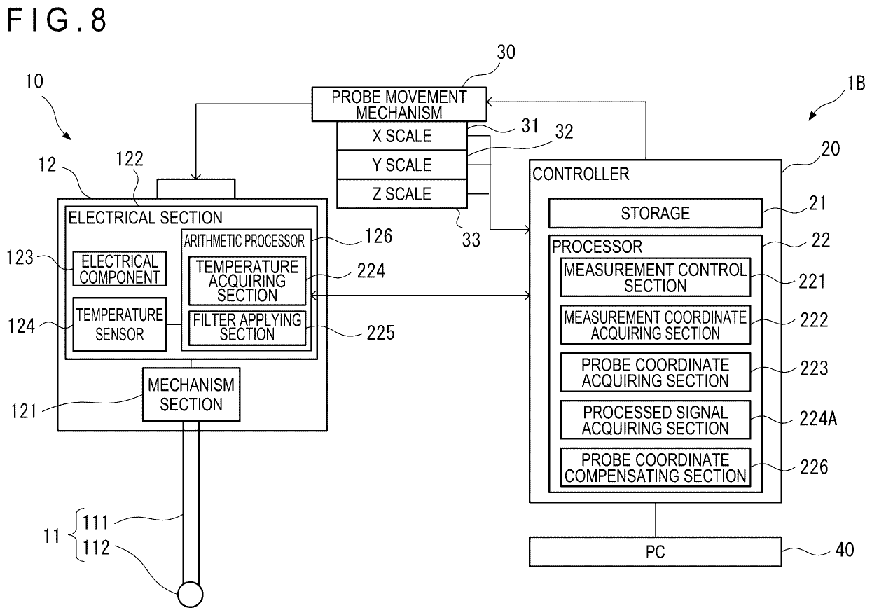

FIG. 8 illustrates a schematic configuration of a coordinate measuring machine 1B according to the third exemplary embodiment.

In the coordinate measuring machine 1B illustrated in FIG. 8, an arithmetic processor 126 is provided for the electrical section 122 of the probe 10. The arithmetic processor 126 functions as the temperature acquiring section 224 and the filter applying section 225 by executing a software program(s). The functions of the temperature acquiring section 224 and the filter applying section 225 are the same as those in the first exemplary embodiment. Specifically, the temperature acquiring section 224 acquires a detection signal corresponding to a measurement temperature output from the temperature sensor 124, and outputs the detection signal to the filter applying section 225. The filter applying section 225 applies the low-pass filtering process to the detection signal input thereto and outputs a processed signal after the low-pass filtering process to the controller 20.

Further, similar to the second exemplary embodiment, the processor 22 of the controller 20 functions as the processed signal acquiring section 224A to acquire the processed signal after the low-pass filtering process. The probe coordinate compensating section 226 then outputs a measurement result obtained by compensating a measurement value based on a temperature T_{L} that corresponds to the processed signal acquired by the processed signal acquiring section 224A.

The third exemplary embodiment described above achieves workings and effects similar to those of the first and second exemplary embodiments.

### Fourth Exemplary Embodiment

In the third exemplary embodiment, the example is given in which the filter applying section 225 is provided in the probe 10. However, the filter applying section 225 may be provided in any part of the coordinate measuring machine. In a fourth exemplary embodiment, an example is given in which the filter applying section 225 is provided for the PC 40.

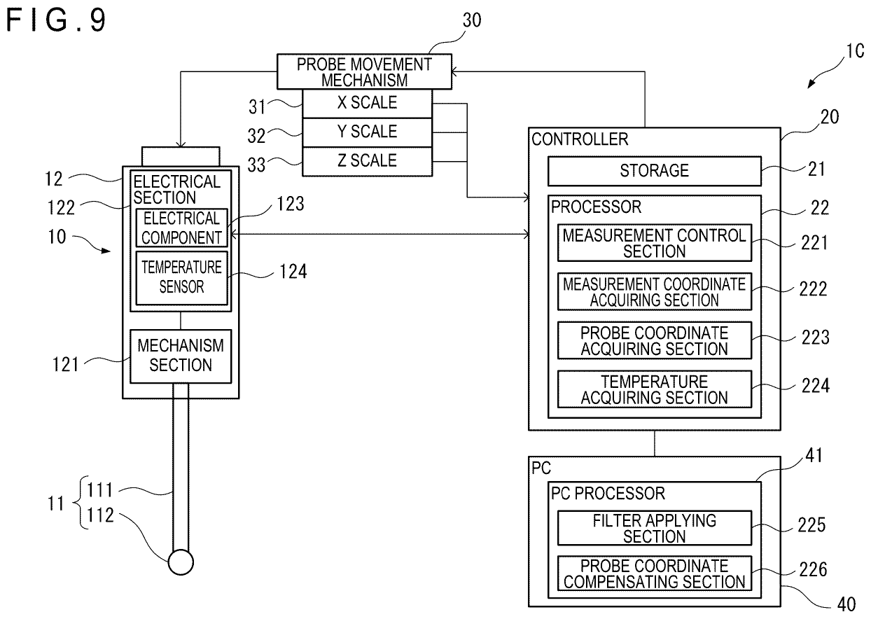

FIG. 9 illustrates a schematic configuration of a coordinate measuring machine 1C according to the fourth exemplary embodiment.

For instance, in the coordinate measuring machine 1C illustrated in FIG. 9, a PC processor 41 provided for the PC 40 functions as the filter applying section 225 and the probe coordinate compensating section 226 by executing a software program(s). In this case, the temperature acquiring section 224 of the controller 20 acquires a detection signal corresponding to a temperature measured by the temperature sensor 124, and transmits the detection signal to the PC 40. The controller 20 also transmits, to the PC 40, measurement coordinates acquired by the measurement coordinate acquiring section 222 and probe coordinates acquired by the probe coordinate acquiring section 223.

The filter applying section 225 of the PC 40 receives a detection signal from the controller 20 and applies the low-pass filtering process to the detection signal to generate a processed signal, as in the first exemplary embodiment.

The probe coordinate compensating section 226 receives the measurement coordinates and probe coordinates from the controller 20, and compensates a measurement value based on the processed signal after the low-pass filtering process to calculate a measurement result.

The fourth exemplary embodiment described above achieves workings and effects similar to those of the first to third exemplary embodiments.

### Modifications

It should be noted that the invention is not limited to the above exemplary embodiments and includes the following modifications as long as the object of the invention is achievable.

### Modification 1

In each of the above exemplary embodiments, the example is given in which the probe 10 including the stylus 11 functions as the measurement performing unit and the temperature of the probe 10 is measured by the temperature sensor 124 provided for the electrical section 122 built in the support 12 of the probe 10. The invention, however, is not limited thereto.

For instance, temperatures of the X scale 31, Y scale 32, and Z scale 33 in the coordinate measuring machines 1, 1A, 1B, and 1C may be measured by the measurement performing unit and then compensated. In this case, the X scale 31 includes, for instance, a scale with scale marks and an electrical section (detection head) provided with an encoder or the like that reads the scale marks of the scale. A temperature sensor is provided for the detection head that is the electrical section, the low-pass filtering process is applied to a detection signal output from the temperature sensor to generate a processed signal, and a measurement value measured by the X scale 31 is compensated based on the processed signal.

Providing the temperature sensor for the electrical section that is the heat source makes it possible to properly compensate the measurement value so as to correspond to elongation of the entire X scale 31, even when the temperature of the temperature sensor is different from that in each part of the X scale 31.

The same applies to the Y scale 32 and the Z scale 33.

The above is an example of the X scale 31, Y scale 32, and Z scale 33 provided for the coordinate measuring machines 1, 1A, 1B, and 1C. Such an example is also applicable to any other measuring apparatus. For instance, in a length measuring machine that measures a length of a measurement target in one direction (X direction), the length of the measurement target is measured by a scale (measurement performing unit) disposed along a longitudinal direction. In this case, an electrical section provided in a part of the scale (e.g., a reader that reads a value of the scale such as an encoder) may include a temperature sensor, the low-pass filter may be applied to a detection signal output from the temperature sensor to generate a processed signal as in the first and second exemplary embodiments, and the length (measurement value) measured by the scale may be compensated based on the processed signal.

### Modification 2

In the second exemplary embodiment, the example is given in which the low-pass filter circuit 125 is provided for the electrical section 122 built in the support 12 of the probe 10. The invention, however, is not limited thereto.

The low-pass filter circuit may be provided for any of transmission circuits through which a signal is transmitted from the temperature sensor 124 to the controller 20. For instance, the low-pass filter circuit 125 may be provided for a circuit board on which the processor 22 of the controller 20 is provided to be connected to an input terminal to which a detection signal from the temperature sensor 124 is input.

### Modification 3

In the first exemplary embodiment, the example is given in which the filter applying section 225 calculates the temperature T_{L} after the low-pass filtering process based on Formula (2). The invention, however, is not limited thereto.

For instance, moving average represented by Formula (3) is usable in place of Formula (2).

$${T}_{L} [ n ] = \frac{{T}_{S} [ n ] + {T}_{S} [ n - 1 ] + {T}_{S} [ n - 2 ] + … + {T}_{S} [ n - i ]}{i + 1} \qquad ( 3 )$$

In the first exemplary embodiment, a backward difference system as represented by Formula (2) is used as a method of converting the low-pass filtering process for an analog signal into a digital signal. However, other formulae such as a bilinear transform and an impulse invariant method are also usable. For instance, Formula (4) can be used for a first-order low-pass filter using the bilinear transform.

$${T}_{L} [ n ] = A \times {T}_{S} [ n ] - A \times {T}_{S} [ n - 1 ] - B \times {T}_{L} [ n - 1 ] \\ where \\ A = \frac{Δ t}{Δ t + 2 τ} \\ B = \frac{Δ t - 2 τ}{Δ t + 2 τ} \qquad ( 4 )$$

In Formula (4), Δt represents a sampling period and T represents a time constant. The intensity of the low-pass filter can be determined by the time constant τ.

The same applies to the third and fourth exemplary embodiments in which the low-pass filtering process is performed by executing the software program(s).

The following is further disclosed regarding the embodiments including the above examples.

[1] A measuring apparatus, including: a measurement performing unit configured to perform a measurement process on a measurement target; an electrical section disposed in a part of the measurement performing unit; a temperature sensor provided for the electrical section and configured to output a detection signal based on a temperature obtained by measurement; and a measurement calculator configured to calculate a measurement result of the measurement target, in which the measurement calculator is configured to calculate the measurement result by compensating a measurement value obtained by the measurement process based on a processed signal obtained by applying a low-pass filter to the detection signal output from the temperature sensor.

In such a configuration, the temperature sensor measures the temperature of the electrical section that is a heat source. For instance, immediately after the power source of the measuring apparatus is turned on, the temperature of the temperature sensor changes steeply. However, it is possible to convert the detection signal that corresponds to the steep temperature change and of which signal value changes steeply, to the processed signal of which signal value changes gradually, by applying the low-pass filter to the detection signal output from the temperature sensor. Compensating the measurement value based on the processed signal enables the compensation process corresponding to the slower temperature change in the measurement performing unit. That is, it is possible to perform the proper compensation process corresponding to the actual temperature in the measurement performing unit.

[2] The measuring apparatus according to [1], in which the low-pass filter is a filter program recorded in a storage, and the measurement calculator is configured to read and execute the filter program recorded in the storage and to calculate the processed signal by applying the low-pass filter to the detection signal output from the temperature sensor.

Such a configuration eliminates the low-pass filter circuit that converts the detection signal from the temperature sensor to the processed signal, simplifying the configuration of the measuring apparatus. In addition, such a configuration facilitates the update of the filter program, and the program can be updated to obtain the measurement result with high accuracy, regardless of the change in the installation environment of the measuring apparatus, the replacement of the measurement performing unit, etc.

[3] The measuring apparatus according to [1], in which the low-pass filter is a low-pass filter circuit, and the detection signal output from the temperature sensor is to be input to the low-pass filter circuit, and the processed signal output from the low-pass filter circuit is to be input to the measurement calculator.

In this configuration, the processed signal is generated by processing the detection signal from the temperature sensor in the low-pass filter circuit. Thus, the measurement calculator does not need to perform the arithmetic process relating to the low-pass filter, reducing the processing load relating to the calculation.

[4] The measuring apparatus according to [1], in which the measurement performing unit is a probe including a stylus configured to make contact with the measurement target and a support supporting the stylus, and the electrical section and the temperature sensor are provided inside the support.

Such a probe including the stylus and the support performs the measurement process by bringing the stylus into contact with the measurement target. Here, in the probe in which the temperature sensor is provided for the electrical section, the temperature sensor measures the temperature of the electrical section that is the heat source. However, it takes a long time for heat to propagate to each part of the probe, making the temperature increase to the elapsed time slow. Further, heat dissipates more greatly with distance from the electrical section, resulting in a decrease in saturated temperature. Thus, the elongation of the entire probe due to the temperature increase can not be compensated directly from the steeply-increasing temperature measured by the temperature sensor. In contrast, in this aspect of the invention, the measurement value is compensated based on the processed signal obtained by applying the low-pass filter to the detection signal corresponding to the temperature measured by the temperature sensor. This makes it possible to perform the proper compensation process corresponding to the elongation of the entire probe. In addition, in the configuration in which the temperature sensor is provided for the electrical section inside the support as in this aspect of the invention, it is possible to reduce the number of temperature sensors compared to a case where the temperature sensors are provided for respective parts of the probe such as the stylus, to prevent the temperature sensor from interfering with the measurement target and other components of the measuring apparatus, and to simplify the wiring arrangement of the temperature sensor.

What is claimed is:

1. A measuring apparatus, comprising:
a measurement performing unit configured to perform a measurement process on a measurement target;
an electrical section disposed in a part of the measurement performing unit;
a temperature sensor provided for the electrical section and configured to output a detection signal based on a temperature obtained by measurement; and
a measurement calculator configured to calculate a measurement result of the measurement target, wherein
the measurement calculator is configured to calculate the measurement result by compensating a measurement value obtained by the measurement process based on a processed signal obtained by applying a low-pass filter to the detection signal output from the temperature sensor.

2. The measuring apparatus according to claim 1, wherein
the low-pass filter is a filter program recorded in a storage, and
the measurement calculator is configured to read and execute the filter program recorded in the storage and to calculate the processed signal by applying the low-pass filter to the detection signal output from the temperature sensor.

3. The measuring apparatus according to claim 1, wherein
the low-pass filter is a low-pass filter circuit, and
the detection signal output from the temperature sensor is to be input to the low-pass filter circuit, and the processed signal output from the low-pass filter circuit is to be input to the measurement calculator.

4. The measuring apparatus according to claim 1, wherein
the measurement performing unit is a probe including a stylus configured to make contact with the measurement target and a support supporting the stylus, and
the electrical section and the temperature sensor are provided inside the support.
